(19) United States
(12) Patent Application Publication
(10) Pub. No.: US 2009/0017793 A1
(43) Pub. Date: Jan. 15, 2009

(54) SYSTEM AND METHOD FOR PROVIDING RECORDING SERVICE OF COMMUNICATION IN BASE STATION

(75) Inventors: Man Ho Park, Daejeon (KR); Song In Choi, Daejeon (KR); Jee-Hwan Ahn, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/171,331

(22) Filed: Jul. 11, 2008

(30) Foreign Application Priority Data
Jul. 13, 2007 (KR) 10-2007-0070564

(51) Int. Cl. H04M 11/10

(52) U.S. Cl. 455/413

(57) ABSTRACT

The present invention relates to a system and method for providing a recording service. According to an embodiment of the present invention, while a user uses a conversation service by a mobile communication terminal, it is possible to record contents of conversation, which are stored in a base station and correspond to a predetermined period before the present time, as well as contents of conversation after the present time by using a permanent storage medium, according to a user's demand within a predetermined time during conversation or after completion of the conversation. Accordingly, when needing to record the contents of the present conversation, the user can store necessary contents through a simple operation without again requesting conversation to a person.

### CROSS-REFERENCE TO RELATED APPLICATION

This application claims priority to and the benefit of Korean Patent Application No. 10-2007-0070564 filed in the Korean Intellectual Property Office on Jul. 13, 2007, the entire contents of which are incorporated herein by reference.

### BACKGROUND OF THE INVENTION

(a) Field of the Invention

The present invention relates to a system and method for providing a recording service, and more particularly, to a system and method for providing a recording service of communication contents in a base station.

The present invention is supported by the IT R&D program of MIC/IITA [2006-S-009-02, The Development of WiBro Service and Operating Standard].

(b) Description of the Related Art

As mobile communication technology is developed, user classes are being widened without distinction of age or gender, and the popularization of a mobile communication terminal has a large effect on lifestyles of users. That is, since the mobile communication terminal can be conveniently carried and can allow a user to communicate with a desired person without limitation on time and place, the use of the mobile communication terminal is further increased.

Due to information needing to be recorded and contents such as phone numbers, mobile communication terminal numbers, fax numbers, or bank account numbers among information sent by the mobile communication terminal, a communication user requires a separate recording unit. Further, the accuracy of recording and playback of recorded voice data, which is produced as circumstantial evidence, is much better than a human's perception and memory. In addition, since voice is used at a law court, the recorded voice data is accepted as very credible evidence together with photographs. For this reason, the recorded voice data has been used as very important evidence.

However, when a voice recording service is provided in the related art, the recording of the contents sent during the conversation is performed at the time of a user's recording request. For this reason, a user should request the repeated sending of information to a person in order to record the contents of conversation. There is a problem in that the user should recognize the necessity of recording and be ready for recording before conversation to record the information unless requesting the sending of information.

The above information disclosed in this Background section is only for enhancement of understanding of the background of the invention and therefore it may contain information that does not form the prior art that is already known in this country to a person of ordinary skill in the art.

### SUMMARY OF THE INVENTION

Accordingly, the present invention has been made in an effort to provide a system and method for providing a service to a user from a base station if a user wants to record contents of conversation within a predetermined time during conversation or after the completion of the conversation.

An exemplary embodiment of the present invention provides a system for providing a recording service. The system includes a temporary storage unit that stores the contents of a conversation generated by a mobile communication terminal in the form of a voice packet for a predetermined period, a permanent storage unit that receives and stores the contents of conversation of the voice packet stored in the temporary storage unit and provides the contents of conversation of the stored voice packet through the mobile communication terminal, and a function controller that receives a recording service request signal generated by the mobile communication terminal and generates a control signal so as to move the contents of conversation of the voice packet stored in the temporary storage unit to the permanent storage unit.

Another exemplary embodiment of the present invention provides a method of providing a recording service. The method includes receiving a recording service request signal through a mobile communication terminal, confirming a storage point of time of a voice packet, which is used to provide a recording service, on the basis of the request signal, moving contents of a conversation of a voice packet, which are stored in a temporary storage unit, to a permanent storage unit, and storing the contents of conversation, and providing the contents of conversation of the voice packet, which is stored in the permanent storage unit, through the mobile communication terminal when a providing request is generated.

According to the embodiments of the present invention, it is possible to record the contents of a conversation, which are stored in a base station and correspond to a predetermined period before the present time, as well as contents of a conversation after the present time by using a permanent storage medium, according to a user's demand within a predetermined time during conversation or after the completion of the conversation.

Further, when needing to record the contents of the present conversation, the user can store necessary contents through a simple operation without again requesting conversation to a person, and can listen to the contents later according to a user's demand.

### BRIEF DESCRIPTION OF THE DRAWINGS

FIG. 1 is a view showing the configuration of a system for providing a recording service of communication contents according to an exemplary embodiment of the present invention.

FIG. 2 is a flowchart illustrating a method of providing a recording service of communication contents according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof. In addition, the terms “-er”, “-or”, and “module” described in the specification mean units for processing at least one function and operation, and can be implemented by hardware components or software components, and combinations thereof.

In this specification, a mobile station (MS) may represent a terminal, a mobile terminal (MT), a subscriber station (SS), a portable subscriber station (PSS), user equipment (UE), an access terminal (AT), and the like. Further, the mobile station may have all or partial functions of the mobile terminal, the subscriber station, the portable subscriber station, the user equipment, and the like.

In this specification, a base station (BS) may represent an access point (AP), a radio access station (RAS), a node B, a base transceiver station (BTS), a mobile multihop relay (MMR)-BS, and the like. Further, the base station may have the entire or partial function of the access point, the radio access station, the node B, the base transceiver station, the MMR-BS, and the like.

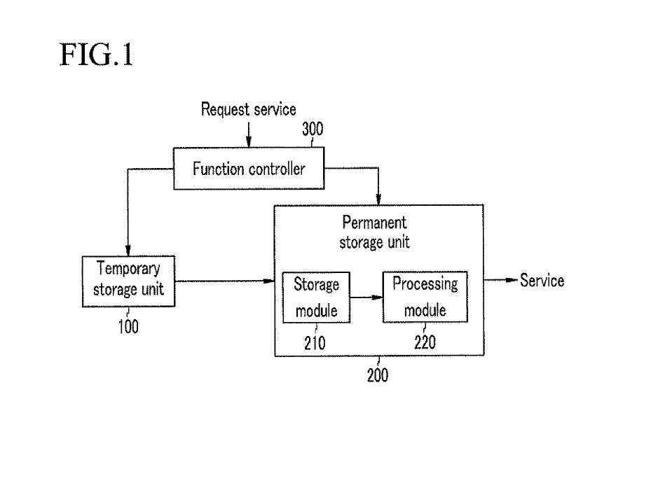

FIG. 1 is a view showing the configuration of a system for providing a recording service of communication contents according to an exemplary embodiment of the present invention.

As shown in FIG. 1, the base station includes a temporary storage unit 100, a permanent storage unit 200, and a function controller 300 in order to provide a recording service of communication contents.

The temporary storage unit 100 stores the contents of user's conversation by using a high-speed memory, which has a predetermined capacity, in the base station in the form of an encoded voice packet. Further, according to a control signal of the function controller 300 to be described below, the contents of conversation after the present time or the contents of conversation corresponding to call duration within the range of capacity of the high-speed memory are moved to a permanent storage medium of the permanent storage unit 200. In this case, the temporary storage unit 100 uses a high-speed memory, and may be embodied in the form of a random access memory (RAM). However, the temporary storage unit is not necessarily limited thereto.

The permanent storage unit 200 includes a storage module 210 and a processing module 220. The storage module 210 of the permanent storage unit 200 receives the contents of user's conversation from the temporary storage unit 100 according to a control signal of the function controller 300, and stores the contents of user's conversation. Alternatively, when receiving a deletion control signal from the function controller 300, the permanent storage unit 200 deletes corresponding contents of conversation. Further, the permanent storage unit 200 provides the contents of conversation to a user in the form of a voice mail or a short message according to a user's request, but is not necessarily limited thereto. In this case, in order to provide the contents of conversation to a user in the form of a voice mail or a short message, the processing module 220 of the permanent storage unit 200 also performs a function to process the contents of conversation into a corresponding form.

The permanent storage unit 200 is embodied in the form of a storage medium that has a lower speed as compared to the temporary storage unit 100. For example, the permanent storage unit 200 may be embodied in the form of a hard disk or a magnetic tape, but is not necessarily limited thereto.

The function controller 300 sends a control signal to the temporary storage unit 100 according to a user's control signal and commands to send the contents of voice conversation, which are generated after user's input, to the permanent storage unit 200. Further, the function controller 300 commands that the temporary storage unit 100 send the contents of conversation corresponding to a predetermined period among the contents stored in the high-speed memory of the temporary storage unit 100 to the storage module 210 of the permanent storage unit 200. Then, a control of the function controller 300 is performed so that the contents of conversation are provided in the form of voice or in the processed form according to a user's request. Furthermore, the function controller 300 generates a deletion or storage control signal of the contents of conversation on the basis of a request related to deletion or storage for the contents of conversation, which are input by a user and permanently stored and sends the deletion or storage control signal to the storage module 210 of the permanent storage unit 200.

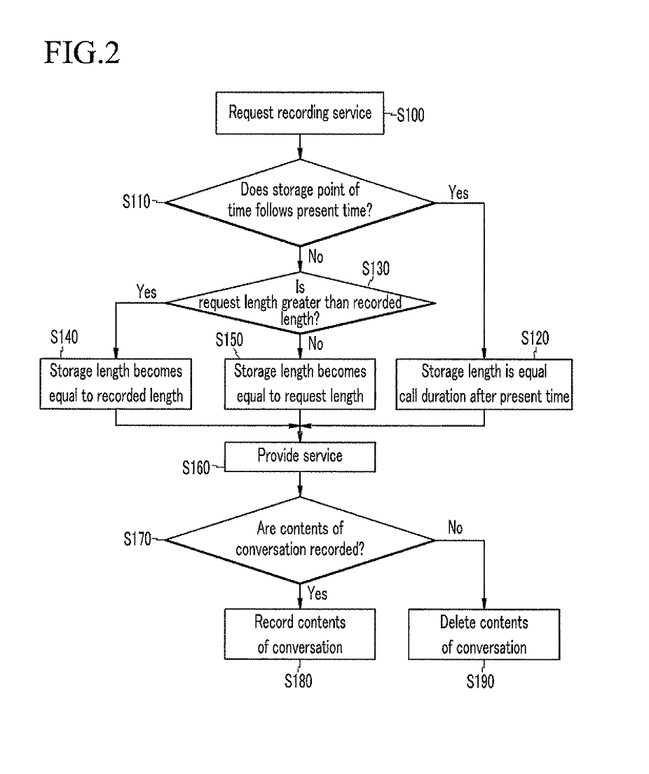

A method of providing a recording service using the system for providing a recording service of communication contents, which has been described above, will be described with reference to FIG. 2.

FIG. 2 is a flowchart illustrating a method of providing a recording service of communication contents according to another exemplary embodiment of the present invention.

As shown in FIG. 2, if a user is in need of the storage of the contents of conversation when beginning conversation using a mobile communication terminal or while conversing with a person, the beginning of a recording service is requested to the function controller 300 of the base station through a key input performed by the user (S100). The function controller 300 receiving the user's service request determines whether an object of the recording service is the contents of conversation after the present time or the contents of conversation corresponding to a predetermined period before the present time. That is, the function controller 300 determines a storage point of time that is requested by the user (S110).

If the storage point of time precedes a point of time when the user's service request is generated, that is, if the contents of the service requested by the user correspond to a request related to the storage of contents of conversation after the present time, the function controller 300 generates a control signal so that the contents of conversation generated after the present time are moved from the temporary storage unit 100 to the storage module 210 of the permanent storage unit 200 and stored. In this case, a storage length corresponding to the storage point of time is equal to the call duration after the present time (S120). However, if the storage point of time does not precede the point of time when the user's service request is generated, that is, if the contents of the service request correspond to a request related to the storage of contents of conversation before the present time, the function controller 300 examines a storage length of the contents of conversation that is requested by the user, that is a request length.

The length of the contents of conversation stored in the temporary storage unit 100, that is a recorded length is compared with the request length (S130). A shorter time length is selected from the result of the comparison, and the contents of conversation are moved from the temporary storage unit 100 to the permanent storage unit 200 based on the shorter time length and stored.

That is, the following case will be exemplified in another exemplary embodiment of the present invention. Conversation begins at 13:00, a request length (a) of the contents of conversation that are to be stored by a user at 13:05 is set to 4 minutes, and the contents of conversation are recorded. Further, it is assumed that the contents of conversation are temporarily stored in the temporary storage unit 100 with a recorded length (b) being within 3 minutes. In this case, since “a” is larger than “b”, the recorded length corresponding to the contents of conversation stored in the temporary storage unit 100 is determined to be a storage length corresponding to the storage point of time (S140). Then, the contents of conversation that are stored in the temporary storage unit 100 after 13:02 are moved to the permanent storage unit 200 based on the determined storage length.

In contrast, the following case will be exemplified. A request length (a) of the contents of conversation that are to be stored by a user at 13:05 is set to 2 minutes, and the contents of conversation are recorded. In this case, since (a) is smaller than (b) (2 minutes<3 minutes), the request length requested by the user is determined to be the storage length (S150). Then, the contents of conversation that are stored in the temporary storage unit 100 after 13:03 are moved to the permanent storage unit 200 based on the determined storage length. In this case, the contents of conversation stored in the temporary storage unit 100 are maintained for a predetermined period after the termination of the user's conversation, and the contents are deleted if there is no recording request during this period.

Next, the contents of conversation that are stored in the storage module 210 of the permanent storage unit 200 may be provided in the form of a voice service according to a user's request, or may be processed in a different form such as a short message by the processing module 220 of the permanent storage unit 200 and then provided to a user. In this case, if being provided in the form of the voice service, the contents of conversation may be provided in the form of an existing voice mailbox service (S160).

After the service is provided to the user, the function controller 300 to which the user inputs whether the contents of conversation of the voice packet stored in the storage module 210 are recorded determines whether the input corresponds to the recording of the contents of conversation (S170). If the user wants to record the contents of conversation, the function controller 300 continuously sends storage control signals to the storage module 210 so that the storage module 210 stores the contents of conversation (S180). However, if the user wants to delete the contents of conversation, the function controller 300 sends a deletion control signal to the permanent storage unit 200 indicating that the contents of conversation are to be deleted. Then, the permanent storage unit 200 deletes corresponding contents of conversation from the storage module 210 (S190).

The above-mentioned exemplary embodiments of the present invention are not embodied only by a method and apparatus. Alternatively, the above-mentioned exemplary embodiments may be embodied by a program performing functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for providing a recording service, the system comprising:
a temporary storage unit that stores the contents of conversation generated by a mobile communication terminal in the form of a voice packet for a predetermined period;
a permanent storage unit that receives and stores the contents of conversation of the voice packet stored in the temporary storage unit, and provides the contents of conversation of the stored voice packet through the mobile communication terminal; and
a function controller that receives a recording service request signal generated by the mobile communication terminal, and generates a control signal so as to move the contents of conversation of the voice packet stored in the temporary storage unit to the permanent storage unit.

2. The system of claim 1, wherein the permanent storage unit includes:
a storage module that receives and stores the contents of conversation of the voice packet stored in the temporary storage unit on the basis of the control signal of the function controller; and
a processing module that processes the contents of conversation of the voice packet stored in the storage module into a form that is requested by a user of the mobile communication terminal, where the form requested by the user corresponds to one of a voice mailbox and a short message, and provides the contents of conversation to the mobile communication terminal.

3. A method of providing a recording service in a base station, the method comprising:
receiving a recording service request signal through a mobile communication terminal;
confirming a storage point of time of a voice packet that is used to provide a recording service, on the basis of the request signal;
moving contents of conversation of the voice packet, which is stored in a temporary storage unit, to a permanent storage unit based on the storage point of time, and storing the contents of conversation ; and
providing the contents of conversation of the voice packet that is stored in the permanent storage unit, through the mobile communication terminal when a providing request is generated.

4. The method of claim 3, wherein the moving contents includes:
determining whether the storage point of time precedes a point of time when the recording service request signal is generated;
comparing a request length of the contents of conversation to be stored in the permanent storage unit with a recorded length of the contents of conversation stored in the temporary storage unit if the storage point of time does not precede the point of time when the recording service request signal is generated;
determining the recorded length as a storage length corresponding to the storage point of time request if the request length is longer than the recorded length; and
moving the contents of conversation of the voice packet, which is stored in a temporary storage unit before the present time, to a permanent storage unit based on the storage length and storing the contents of conversation.

5. The method of claim 4, wherein the moving contents further includes:
determining the request length as a storage length corresponding to the storage point of time request if the request length is not longer than the recorded length; and
moving the contents of conversation of the voice packet, which is stored in a temporary storage unit, to a permanent storage unit based on the storage length and storing the contents of conversation.

6. The method of claim 4, wherein the moving contents further includes:
moving contents of conversation of the voice packet, which is to be stored in a temporary storage unit after the present time, to a permanent storage unit if the storage point of time proceed the point of time when the recording service request signal is generated and storing the contents of conversation.

7. The method of claim 3, wherein the providing of the contents through the mobile communication terminal includes:
providing the contents of conversation of the voice packet stored in the permanent storage unit to a voice mailbox, if the providing request is in the form of voice; and
processing the voice packet stored in the permanent storage unit into a short message and providing the voice packet in the form of a short message, if the providing request is a short message.

8. The method of claim 7, further comprising
after the providing of the contents through the mobile communication terminal:
determining whether the contents of conversation of the voice packet stored in the permanent storage unit are recorded through the mobile communication terminal;
deleting the contents of conversation of the voice packet stored in the permanent storage unit, if deletion of the contents of conversation is requested; and
recording the contents of conversation of the voice packet stored in the permanent storage unit, if recording of the contents of conversation is requested.
